(19) United States
(12) Patent Application Publication
(10) Pub. No.: US 2026/0104551 A1
(43) Pub. Date: Apr. 16, 2026

(54) CONNECTOR ASSEMBLY

(71) Applicant: MD Elektronik GmbH, Waldkraiburg (DE)

(72) Inventors: Thomas Halbig, Dietfurt (DE); Stefan Fuchs, Ampfing (DE); Rudolf Engl, Ampfing (DE)

(21) Appl. No.: 19/336,545

(22) Filed: Sep. 23, 2025

(30) Foreign Application Priority Data
Oct. 10, 2024 (DE) 10 2024 129 239.3

(51) Int. Cl. G02B 6/38

(52) U.S. Cl. CPC G02B 6/3821; G02B 6/3873

(57) ABSTRACT

A connector assembly includes a connector housing which, at a mating end, is connectable to a mating connector, a cable having at least one optical waveguide enclosed by a cable jacket, an attachment unit connected to the cable at a cable end, a damping unit disposed within the connector housing, and a contact unit having at least one contact end. The optical waveguide protrudes from the cable jacket at the cable end, the damping unit has a receiving chamber in which at least a portion of the contact unit is disposed, and the optical waveguide extends through the contact unit to the contact end. The optical waveguide is connected to the mating connector in signal-conducting relationship, the attachment unit has a latching element, which is connected to a complementary latching element on the connector housing, a first spring element is disposed between the damping unit and the attachment unit.

### CROSS REFERENCE TO RELATED APPLICATIONS

This application claims benefit to German Patent Application No. 102024129 239.3, filed on October 10, 2024, which is hereby incorporated by reference herein.

### FIELD

The invention relates to a connector assembly system for optical signal cables.

### BACKGROUND

Optical signal cables, such as fiber-optic cables, have been established in practice for decades for the transmission of large volumes of signals and data. In the wake of digitization and automation, and the associated increase in the required data volumes, optical signal cables are increasingly being used in areas where electrical signal cables have long been predominant. This is mainly due to the fact that the required transmission quantities are becoming increasingly difficult to provide using electrical signal cables. However, as the applications of optical signal cables expand into new fields, the requirements placed on optical signal cables and on connector systems allowing connection of optical signal cables change as well. Consequently, there is an increasing need for economical connector systems for optical signal cables that are both resistant to environmental influences and resistant to mechanical stresses which may act on the pluggable connection during the mating process or in the mated condition.

In the case of cable-mounted connectors, it is in particular required that a reliable optical signal connection between the connector and a mating connector connected thereto is maintained, even when tensile forces are exerted on the connector or the cable.

### SUMMARY

In an embodiment, the present disclosure provides a connector assembly includes a connector housing which, at a mating end, is connectable to a mating connector, a cable having at least one optical waveguide enclosed by a cable jacket, an attachment unit connected to the cable at a cable end, a damping unit disposed within the connector housing, and a contact unit having at least one contact end. The optical waveguide protrudes from the cable jacket at the cable end, the damping unit has a receiving chamber in which at least a portion of the contact unit is disposed, and the optical waveguide extends through the contact unit to the contact end. The optical waveguide is connected to the mating connector in signal-conducting relationship therewith, the attachment unit has a first latching element, which is connected to a first complementary latching element on the connector housing, a first spring element is disposed between the damping unit and the attachment unit. The first spring element biases the damping unit in the direction of the mating end against an abutment surface of the connector housing, the contact unit is supported by resilient supporting elements within the connector housing and/or the receiving chamber. The supporting elements are configured to retain the contact unit in an initial position and to apply a force thereto that forces the contact unit back to the initial position when the contact unit is moved radially to the mating axis out of the initial position.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a perspective exploded view of an embodiment of a connector assembly according to the present disclosure;

FIG. 2 is a perspective view of an embodiment of the damping unit of the connector assembly according to the present disclosure;

FIG. 3 is a sectional view of another embodiment of the connector assembly according to the present disclosure; and

FIG. 4 is a sectional view of an embodiment of an attachment unit, a damping unit, and a contact unit of the connector assembly according to the present disclosure.

### DETAILED DESCRIPTION

Embodiments of the present disclosure provide a connector assembly that is resistant to mechanical loads acting thereon and ensures a reliable signal connection.

A connector assembly according embodiments of the present disclosure includes a connector housing, a cable, an attachment unit, a damping unit, and a contact unit. At a mating end, the connector housing is connectable to a mating connector. The cable has at least one optical waveguide enclosed by a cable jacket. The attachment unit is connected to the cable at a cable end. Preferably, the cable is enclosed by the attachment unit. It is particularly preferred that the attachment unit is connected to the cable jacket by a material-to-material bond and/or by an interlocking connection. The damping unit is disposed within the connector housing. The contact unit has at least one contact end. The contact end can be understood to mean an end where the contact unit can be connected to the mating connector in signal-conducting relationship therewith. The optical waveguide protrudes from the cable jacket at the cable end. The damping unit has a receiving chamber in which at least a portion of the contact unit is disposed. The optical waveguide extends through the contact unit to the contact end. At the contact end, the optical waveguide can be connected to the mating connector in signal-conducting relationship therewith. Therefore, it is preferred that the contact end is formed both by the contact unit and by the optical waveguide. The attachment unit has at least one first latching element. The first latching element is connected to a first complementary latching element on the connector housing. At least one first spring element is disposed between the damping unit and the attachment unit. The spring element biases the damping unit in the direction of the mating end against an abutment surface of the connector housing. Preferably, the spring element acts parallel to a mating axis, so that the damping unit is also biased parallel to the mating axis against the abutment surface. The mating axis can be understood to mean an imaginary axis along which the connector assembly is moved to connect it to a mating connector. The contact unit is supported within the connector housing by resilient supporting elements. In an embodiment of the present disclosure, the contact unit is supported by the supporting elements within the receiving chamber. Because the contact unit is mounted with the aid of the supporting elements, the contact unit is movable radially to the mating axis with respect to the damping element and/or to the connector housing. The supporting elements are configured to retain the contact unit in an initial position and to apply a force thereto that forces the contact unit back to the initial position when the contact unit is moved radially to the mating axis out of the initial position. In this context, an initial position can be understood to mean a position that is assumed by the contact unit supported by the supporting elements when no external forces act on the contact unit.

A connector assembly according to an embodiment of the present disclosure provides a secure and robust connection between the optical waveguide and a mating connector that is plug-compatible with the connector assembly. Since the attachment unit is connected to the cable at the cable end and to the connector, tensile forces acting on the cable can be transferred via the connector housing. Because the spring element biases the damping unit against the abutment surface, it is also ensured that the optical waveguide is always positioned in a defined manner together with the contact unit. Furthermore, after connection of the connector assembly to a mating connector, it is ensured that the contact unit, and thus the optical waveguide, is biased against the mating connector by the first spring element of the damping unit. This ensures a reliable, signal-conducting optical connection, even when the connector assembly is subjected to increased stresses, such as vibrations or shock. Furthermore, during assembly, an easy-to-handle subassembly including the contact unit, the damping unit, and the attachment unit can be formed. This allows assembly in the connector housing without any risk of damaging the optical waveguide. Due to the manner in which the contact unit is mounted in the connector housing or in the receiving chamber of the damping unit, the contact unit is floatingly supported within the connector housing or in the receiving chamber of the damping unit. This can prevent, for example, transverse forces from acting on the contact unit, particularly when connecting the inventive connector assembly to the mating connector. The risk of damage can thus be avoided. Such transverse forces can occur, for example, when the connector is not properly connected to the mating connector parallel to the mating axis, but at an angle to the mating axis. Because the supporting elements exert a force on the contact unit, forcing it back to the initial position, it is ensured that the contact unit always remains correctly positioned, even for multiple mating operations.

The contact unit may have at least one ferrule housing. Furthermore, the contact unit may have at least one contact ferrule mounted in the ferrule housing. In this case, it is preferred that the contact end is located on the contact ferrule. The contact ferrule may partially protrude from the ferrule housing, in particular parallel to the mating axis. Preferably, the contact ferrule is movable radially to the mating axis within the contact unit. This allows the contact ferrule to also be floatingly supported within the contact unit. If the cable has a plurality of optical waveguides, it is preferred that each optical waveguide has associated therewith a contact ferrule, the contact ferrules each having one contact end.

The contact ferrule may be movable relative to the ferrule housing, parallel to the mating axis. If the contact ferrule protrudes from the ferrule housing, it is particularly preferred that the contact ferrule is insertable into the ferrule housing. The contact ferrule may also be biased against a ferrule housing wall by a second spring element. The ferrule housing wall is preferably disposed at an end of the ferrule housing opposite the damping unit. Preferably, the second spring element acts parallel to the mating axis and in a mating direction. In this context, a mating direction can be understood to mean a direction of movement in which the connector assembly is moved relative to the mating connector during connection of the connector assembly to the mating connector.

The contact ferrule may be limited in its path of travel in a direction opposite to the mating direction by an abutment element. Thus, the contact ferrule can be prevented in a simple manner from being pushed too deep into the contact unit and becoming damaged. The limitation of the path of travel of the contact ferrule can be accomplished, for example, by the contact ferrule abutting against the abutment element when the contact ferrule is moved in a direction opposite to the mating direction, and further movement of the contact ferrule in this direction is thereby blocked.

The abutment element may be releasably connected to the ferrule housing. This allows for easy mounting and dismounting of the contact ferrule in the contact unit. In this way, it is also possible, for example, to replace a damaged contact ferrule or a damaged second spring element, the contact unit as well as the abutment element being reusable. The releasable connection between the abutment element and the contact unit may be realized, for example, via a snap-fit connection.

The second spring element may be disposed between the abutment element and the contact ferrule. For this purpose, the contact ferrule may have a collar against which the second spring element abuts. The contact ferrule is preferably partially surrounded by the spring element. It is also preferred that the collar is biased by the second spring element against the ferrule housing wall.

The contact unit may be supported by at least three supporting elements within the connector housing and/or the receiving chamber. The supporting elements are disposed around the mating axis. In this way, only a few supporting elements are needed to ensure that the contact unit is uniformly movable radially to the mating axis and reliably returned to its initial position by the supporting elements. Three supporting elements are advantageous especially when the contact unit is cylindrical in shape. In this case, the supporting elements are preferably distributed at equal angular intervals around the mating axis. If the contact unit has a cross-sectional shape that differs from a cylindrical shape and is in particular mirror symmetrical, then the contact unit may be supported by four or more supporting elements. In this case, the supporting elements may be arranged mirror-symmetrically, the plane of symmetry preferably being parallel to the mating axis.

At least some of the supporting elements may be formed by first resilient tongues. The first resilient tongues may be disposed on the damping unit. Furthermore, the first resilient tongues may project into the receiving chamber and rest against the contact unit. The first resilient tongues may be formed monolithically with the damping unit. In this context, it is advantageous if the damping unit and the first resilient tongues are formed from a thermoplastic material. In this case, the resilient characteristics of the plastic material can be used to produce the spring effect of the first resilient tongues.

At least some of the supporting elements may be formed by second resilient tongues. The second resilient tongues may be disposed on the contact unit. In addition, the second resilient tongues may rest against a housing wall of the connector housing and/or an inner wall of the receiving chamber. The second resilient tongues may be formed monolithically with the contact unit. Furthermore, it is preferred that the contact unit is made of a thermoplastic material. The second resilient tongues preferably extend away from the contact unit. In one specific embodiment of the invention, the damping unit has first resilient tongues which project into the receiving chamber and rest against the contact unit, the contact unit having second resilient tongues which rest against the housing wall.

The contact unit may be releasably connected to the damping unit. For example, the contact unit and the damping unit may be connected to each other via a snap-fit connection. This not only allows easy placement of the contact unit into the receiving chamber and subsequent connection of the contact unit to the damping unit, but also allows the contact unit to be released from the damping unit without being damaged. Preferably, the contact unit and the damping unit are releasably connected to each other within the receiving chamber.

The damping unit can fix the contact unit in position in a direction of movement parallel to the mating axis. Such positional fixing may be accomplished, for example, via the releasable connection between the damping unit and the contact unit.

The attenuation unit may have at least one second latching element. The second latching element may be connected to a second complementary latching element on the connector housing. The second latching element may be formed monolithically with the damping unit. This allows the damping unit to be easily mounted in the connector housing and retained in position. Nevertheless, the damping unit remains substantially mechanically decoupled from the attachment unit, since the damping unit is connected to the attachment unit only via the spring element.

The first spring element may be formed monolithically with the damping unit. In this case, the spring effect of the first spring element is preferably produced by the resilient characteristics of the material from which the damping unit or the first spring element is formed. For example, the damping unit may be formed from a thermoplastic material. Thus, in addition to the shape of the spring element, the spring force of the spring element is essentially determined by the elastic properties of the selected thermoplastic material.

The optical waveguide may be movable relative to the cable jacket along the direction of its longitudinal extent. In other words, the optical waveguide may be floatingly supported relative to the cable jacket. In this context, the direction of longitudinal extent can be understood to mean the direction of the longest extension of the optical waveguide. Because the optical waveguide is floatingly supported relative to the cable jacket, any tensile forces acting on the cable jacket are not transferred to the optical waveguide.

The cable may have a support ferrule at the cable end. The support ferrule may be disposed between the optical waveguide and the cable jacket. The support ferrule may be inserted into the cable jacket at the cable end, with the support ferrule enclosing the optical waveguide. The support ferrule is preferably made of a metal. The support ferrule may be partially enclosed by the attachment unit. Particularly preferably, the support ferrule is fixed in position on the cable end by the attachment unit. By means of the support ferrule, it can be ensured, for example, that the optical waveguide is not damaged when connecting the attachment unit to the cable. If the attachment unit is formed by an injection-molded component, the support ferrule can also ensure that no plastic matrix reaches the optical waveguide.

The support ferrule may have a collar at an end opposite the cable jacket. The collar is preferably funnel-shaped. The collar preferably extends away from the optical waveguide. By means of the collar, it can be ensured, for example, that the optical waveguide does not become damaged at the edge regions of the support ferrule.

The support ferrule may extend through an access opening into a space within the damping unit. The collar may be disposed in this space. Preferably, the access opening has an inner diameter that is smaller than the outer diameter of the collar. Thus, the damping unit is positioned in a defined manner on the attachment unit. This allows for easier mounting of the damping unit together with the attachment unit in the connector housing.

The attachment unit may take the form of an injection-molded component. The injection-molded component may have a plastic matrix. The cable jacket may be connected to a plastic matrix of the attachment unit. Alternatively or additionally, the cable jacket may be embedded in the plastic matrix. The plastic matrix may be connected to the cable jacket by a material-to-material bond. Alternatively or additionally, an interlocking connection may be formed between the cable jacket and the attachment unit by the cable jacket being at least partially embedded in the plastic matrix. The interlocking connection may be formed, for example, by the plastic matrix being disposed in undercuts or recesses in the cable jacket.

The cable may have reinforcing fibers. The reinforcing fibers may be embedded in the plastic matrix of the attachment unit. The reinforcing fibers may be, for example, aramid fibers or polyester fibers. The reinforcing fibers preferably extend along the cable and may enclose the optical waveguide. The reinforcing fibers may be in the form of, for example, woven or knitted fabrics. Preferably, the reinforcing fibers are enclosed by the cable jacket. However, to enable embedding in the plastic matrix, it is preferred that the reinforcing fibers are exposed at the cable end.

In addition, further advantages and features of the present disclosure will be apparent from the following description of exemplary embodiments. The features described therein and hereinabove may be implemented alone or in combination, unless they contradict each other. The following description of the exemplary embodiments is made with reference to the accompanying drawings.

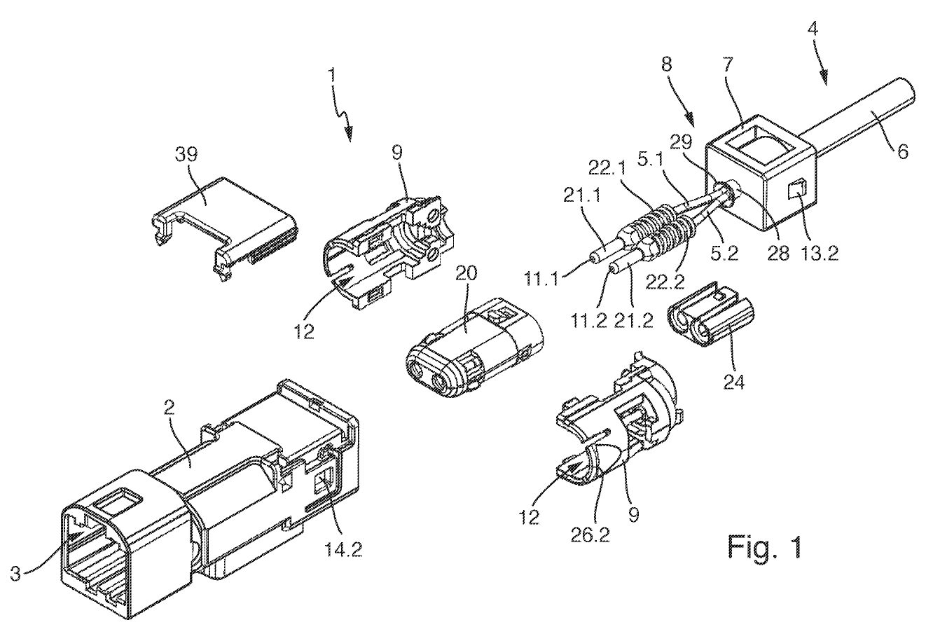

FIG. 1 shows an embodiment of an exemplary connector assembly 1 in a perspective exploded view. Connector assembly 1 includes a connector housing 2 which, at a mating end 3, is connectable to a mating connector. Furthermore, connector assembly 1 includes a cable 4, an attachment unit 7, a damping unit 9, and a contact unit which, in the present embodiment, is formed by a ferrule housing 20 and two contact ferrules 21.1; 21.2. Attachment unit 7 is connected to a cable jacket 6 at a cable end 8 of cable 4. For this purpose, attachment unit 7 encloses cable jacket 6 and is connected to cable jacket 6 by a material-to-material bond and an interlocking connection. In the present embodiment, this is achieved by attachment unit 7 being in the form of a injection-molded component and by cable jacket 6 being embedded in a plastic matrix of attachment unit 7. Cable 4 has two optical waveguides 5.1; 5.2, which protrude from attachment unit 7 at cable end 8. In the region of attachment unit 7, optical waveguides 5.1; 5.2 are enclosed by a support ferrule 28 having a collar 29. Optical waveguides 5.1; 5.2 each extend to a respective one of the contact ferrules 21.1; 21.2 and are partially enclosed thereby. Each of the two contact ferrules 21.1; 21.2 forms a contact end 11.1; 11.2. Optical waveguides 5.1, 5.2 each extend up to a respective contact end 11.1, 11.2. At contact end 11.1; 11.2, optical waveguides 5.1; 5.2 can each be connected to the mating connector in signal-conducting relationship therewith.

Furthermore, for each contact ferrule 21.1; 21.2, a respective second spring element 22.1; 22.2 is disposed within ferrule housing 20. Second spring elements 22.1; 22.2 are retained in ferrule housing 20 by an abutment element 24, which is also inserted into ferrule housing 20. The contact unit, which is formed by ferrule housing 20 and contact ferrules 21.1; 21.2, is disposed within a receiving chamber 12 of damping unit 9. In the present embodiment, damping unit 9 is formed by two joinable half-shells. Damping unit 9 and attachment unit 7 are disposed within connector housing 2. Connector assembly 1 has a secondary locking means 39 to provide for additional fastening.

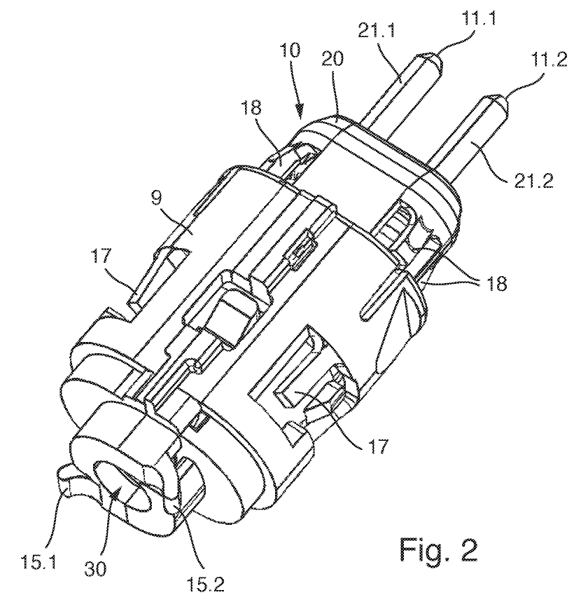

FIG. 2 shows a perspective view of an embodiment of a damping unit 9 of a connector assembly 1 according to the present disclosure. Contact unit 10 is disposed within damping unit 9. Contact unit 10 is releasably connected to damping unit 9 via snap-fit connections. Contact unit 10 is supported within damping unit 9 with the aid of resilient supporting elements. Some of the supporting elements are formed by first resilient tongues 17, which are formed monolithically with damping unit 9. First resilient tongues 17 rest against contact unit 10 within the receiving chamber, retaining contact unit 10 in an initial position. Furthermore, the supporting elements are formed by second resilient tongues 18 disposed on contact unit 10. In the present embodiment, second resilient tongues 18 are formed monolithically with ferrule housing 20. Moreover, the damping element has two first spring elements 15.1; 15.2. The two first spring elements 15.1; 15.2 are formed monolithically with damping unit 9.

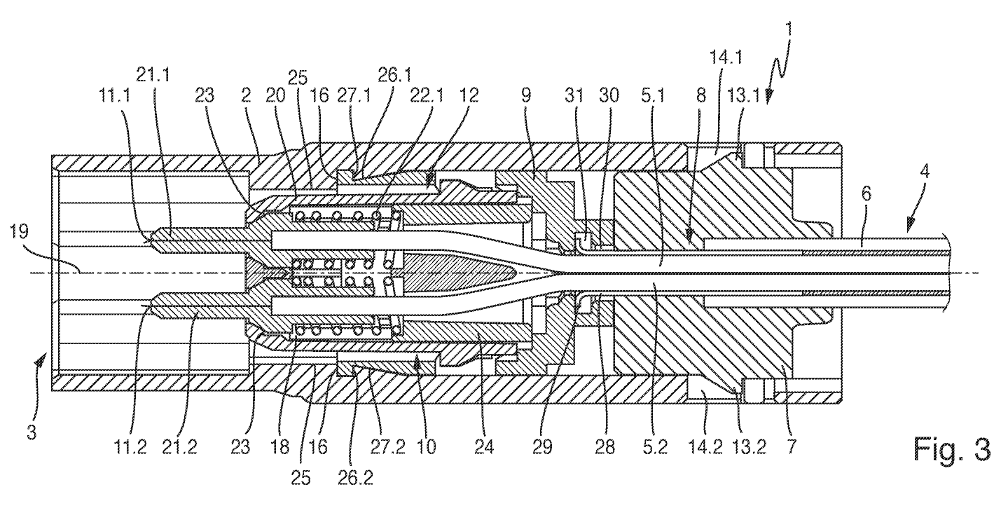

FIG. 3 shows a sectional view of another embodiment of an exemplary connector assembly 1. The sectional plane is parallel to a mating axis 19 and passes through the two optical waveguides 5.1; 5.2. Attachment unit 7 has first latching elements 13.1; 13.2, which are disposed in first complementary latching elements 14.1; 14.2 formed by connector housing 2. Thus, attachment unit 7 is releasably connected to connector housing 2. Cable 4 further has reinforcing fibers 32 which protrude from cable jacket 6 at cable end 8 and are embedded in the plastic matrix of the attachment element. Support ferrule 28 is partially inserted into cable jacket 6, so that support ferrule 28 is partially disposed between optical waveguides 5.1; 5.2 and cable jacket 6. Furthermore, support ferrule 28 is fixed in position on cable end 8 by attachment unit 7. Damping unit 9 has a space 31 formed therein, in which collar 29 is disposed. For this purpose, support ferrule 28 is inserted into space 31 through an access opening 30. Space 31 is separated from receiving chamber 12. Likewise, optical waveguides 5.1; 5.2 are inserted through access opening 30 into receiving chamber 12, where optical waveguides 5.1; 5.2 extend into contact unit 10.

Damping unit 9 includes second latching elements 26.1; 26.2, which are connected to second complementary latching elements 27.1; 27.2 provided on connector housing 2. Thus, damping unit 9 is releasably connected to connector housing 2. The first spring elements (not shown) bias damping unit 9 against an abutment surface 16 of connector housing 2. Optical waveguides 5.1; 5.2 extend through abutment element 24 to the respective contact ferrules 21.1; 21.2 and are partially enclosed thereby. Optical waveguides 5.1, 5.2 extend up to contact ends 11.1, 11.2. Second spring elements 22.1; 22.2 are disposed between the respective contact ferrules 21.1; 21.2 and abutment element 24. Second spring elements 22.1; 22.2 bias the respective contact ferrules 21.1; 21.2 against a ferrule housing wall 23. Second spring elements 22.1; 22.2 act parallel to mating axis 19.

Second resilient tongues 18, which are formed by contact unit 10, rest against a housing wall 25 of connector housing 2. First resilient tongues 17 and second resilient tongues 18 retain contact unit 10 in the initial position, contact unit 10 being movable radially to the mating axis. However, due to the resilient mounting, first and second resilient tongues 17 and 18 force contact unit 10 back to the initial position when the contact unit 10 is moved out of it.

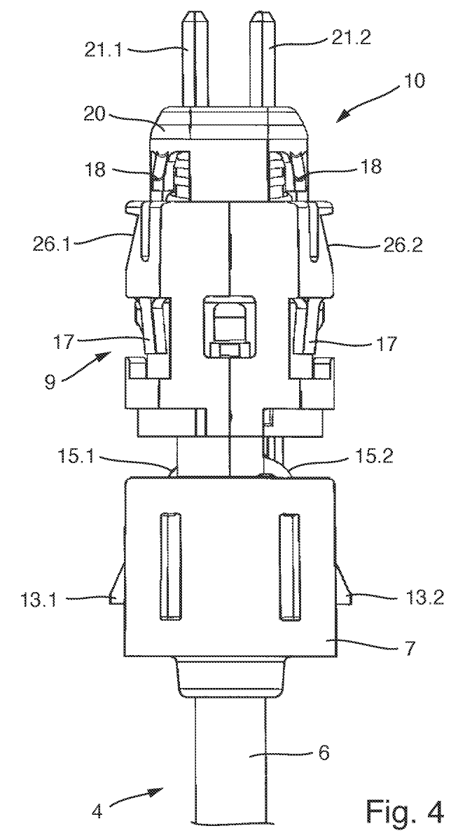

FIG. 4 shows another view of the exemplary connector assembly 1 according to the embodiment of FIG. 3, with the connector housing removed for the sake of clarity. First spring elements 15.1; 15.2 rest against attenuation unit 7, thus biasing damping unit 9 against the abutment surface of the connector housing.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 connector assembly

2 connector housing

3 mating end

4 cable

5 optical waveguide

6 cable jacket

7 attachment unit

8 cable end

9 damping unit

10 contact unit

11 contact end

12 receiving chamber

13 first latching element

14 first complementary latching element

15 first spring element

16 abutment surface

17 first resilient tongues

18 second resilient tongues

19 mating axis

20 ferrule housing

21 contact ferrule

22 second spring element

23 ferrule housing wall

24 abutment element

25 housing wall

26 second latching element

27 second complementary latching element

28 support ferrule

29 collar

30 access opening

31 space

32 reinforcing fibers

39 secondary locking means

1. A connector assembly comprising:
a connector housing which, at a mating end, is connectable to a mating connector,
a cable having at least one optical waveguide enclosed by a cable jacket,
an attachment unit connected to the cable at a cable end,
a damping unit disposed within the connector housing, and
a contact unit having at least one contact end,
wherein
the optical waveguide protrudes from the cable jacket at the cable end,
the damping unit has a receiving chamber in which at least a portion of the contact unit is disposed,
the optical waveguide extends through the contact unit to the contact end, wherein the optical waveguide is connected to the mating connector in a signal-conducting relationship therewith,
the attachment unit has at least one first latching element, which is connected to a first complementary latching element on the connector housing,
at least one first spring element is disposed between the damping unit and the attachment unit, the at least one first spring element biasing the damping unit in a direction of the mating end against an abutment surface of the connector housing,
the contact unit is supported by resilient supporting elements within the connector housing and/or the receiving chamber,
the resilient supporting elements are configured to retain the contact unit in an initial position and to apply a force thereto that forces the contact unit back to the initial position when the contact unit is moved radially to a mating axis out of the initial position.

2. The connector assembly as recited in claim 1, wherein the contact unit has at least one ferrule housing and at least one contact ferrule mounted in the ferrule housing, and wherein the contact end located thereon.

3. The connector assembly as recited in claim 2, wherein the contact ferrule is movable relative to the ferrule housing, parallel to the mating axis, and biased against a ferrule housing wall by a second spring element acting parallel to the mating axis and in a mating direction.

4. The connector assembly as recited in claim 3, wherein the contact ferrule is limited in its path of travel in a direction opposite to the mating direction by an abutment element.

5. The connector assembly as recited in claim 4, wherein the abutment element is releasably connected to the ferrule housing.

6. The connector assembly as recited in claim 4, wherein the second spring element is disposed between the abutment element and the contact ferrule.

7. The connector assembly as recited in claim 1, wherein the contact unit is supported within the connector housing and/or the receiving chamber by at least three supporting elements disposed around the mating axis.

8. The connector assembly as recited in claim 7, wherein at least some of the supporting elements are formed by first resilient tongues which are disposed on the damping unit, project into the receiving chamber, and rest against the contact unit.

9. The connector assembly as recited in claim 8, wherein at least some of the supporting elements are formed by second resilient tongues which are disposed on the contact unit and rest against a housing wall and/or an inner wall of the receiving chamber.

10. The connector assembly as recited in claim 1, wherein the contact unit is releasably connected to the damping unit.

11. The connector assembly as recited in claim 1, wherein the damping unit fixes the contact unit in position in a direction of movement parallel to the mating axis.

12. The connector assembly as recited in claim 1, wherein the damping unit has at least one second latching element which is connected to a second complementary latching element on the connector housing.

13. The connector assembly as recited in claim 1, wherein the first spring element is formed monolithically with the damping unit.

14. The connector assembly as recited in claim 1, wherein the optical waveguide is movable relative to the cable jacket along a direction of its longitudinal extent.

15. The connector assembly as recited in claim 1, wherein the cable has a support ferrule at the cable end, the support ferrule being disposed between the optical waveguide and the cable jacket.

16. The connector assembly as recited in claim 15, wherein the support ferrule has a collar at an end opposite the cable jacket.

17. The connector assembly as recited in claim 16, wherein the support ferrule extends through an access opening into a space within the damping unit, the collar is disposed in the space, and the access opening has an inner diameter that is smaller than an outer diameter of the collar.

18. The connector assembly as recited in claim 1, wherein the attachment unit takes a form of an injection-molded component, and the cable jacket is connected to a plastic matrix of the attachment unit and/or embedded in the plastic matrix.

19. The connector assembly as recited in claim 18, wherein the cable has reinforcing fibers embedded in the plastic matrix of the attachment unit.

20. The connector assembly as recited in claim 16, wherein the support ferrule has a funnel-shaped collar at the end opposite the cable jacket.
